(19) United States
(12) Patent Application Publication
(10) Pub. No.: US 2012/0279494 A1
(43) Pub. Date: Nov. 8, 2012

(54) HOT WATER-FLOWING TYPE SACCHARIFICATION APPARATUS

(76) Inventors: Makoto Kitano, Tokyo (JP); Kenji Sato, Fujisawa-shi (JP); Kentaro Nariai, Yokohama-shi (JP); Tatsuya Oka, Yokohama-shi (JP)

(21) Appl. No.: 13/520,258

(22) PCT Filed: Jan. 18, 2011
(86) PCT No.: PCT/JP2011/050761

§ 371 Date: Jul. 2, 2012

(30) Foreign Application Priority Data
Jan. 18, 2010 (JP) P2010-008553

(51) Int. Cl. B01J 19/00

(52) U.S. Cl. 127/1

(57) ABSTRACT

The hot water-flowing type saccharification apparatus (A) which hydrolyzes a raw material organic substance (X) stored in a reaction pipe (1) by passing pressurized hot water therethrough, includes a raw material hopper (4) which stores the raw material organic substance (X), a raw material-feeding pipe (3) which receives the raw material organic substance (X) dropped from the raw material hopper (4) and communicates with the reaction pipe (1), a raw material transfer unit (5) which transfers the raw material organic substance (X) to the reaction pipe (1) by extruding the raw material organic substance (X) from one end of the raw material-feeding pipe (3) toward the reaction pipe (1), a shutoff valve (2) provided between the raw material-feeding pipe (3) and the reaction pipe (1), a residue discharge unit (6) provided in the reaction pipe (1) on an opposite side to the raw material-feeding pipe (3) so as to discharge a residue (Xa) outside, a pressurized hot water supply unit (7) which supplies pressurized hot water to one end of the reaction pipe (1), and a liquid recovery unit (8) which recovers the pressurized hot water together with a decomposition liquid from the other end of the reaction pipe (1). According to the present invention, a hot water-flowing type saccharification apparatus with which an efficient operation as an industrial process apparatus is possible can be provided.

### TECHNICAL FIELD

The present invention relates to a hot water-flowing type saccharification apparatus.

Priority is claimed on Japanese Patent Application No. 2010-8553, filed on Jan. 18, 2010, the content of which is incorporated herein by reference.

### BACKGROUND ART

In the following Patent Document 1, a technology is disclosed in which a non-water-soluble polysaccharide consisting of 6 to 25 glucose units is produced by hydrolysis, that is, pressurized hot water maintained at a temperature within the range of 270 to 310° C. is passed through a fixed bed filled with cellulose powder at a retention time of less than or equal to 30 seconds. This technology has the aim of producing non-water-soluble polysaccharides using cellulose powder as a raw material.

### DOCUMENTS OF CONVENTIONAL ART

### Patent Document

[Patent Document 1] Japanese Patent No. 3128575

### SUMMARY OF INVENTION

### Technical Problem

The technology disclosed in Patent Document 1 uses a reaction apparatus shown in FIG. 1 of Patent Document 1. However, this reaction apparatus (hot water-flowing type saccharification apparatus) is configured as an experimental apparatus which uses cellulose powder as a raw material, and therefore, cannot be put into practical use as an industrial process apparatus which uses biomass as a raw material. That is, in order to apply a conventional hot water-flowing type saccharification apparatus to an industrial process apparatus which uses biomass as a raw material, the apparatus configuration needs to be optimized so that a more efficient operation is possible with regard to, for example, a feeding mechanism of the biomass (raw material), a discharge mechanism of a residue or the like after processing, or the like.

The present invention has been made in view of the above-described issues and an object thereof is to provide a hot water-flowing type saccharification apparatus with which an efficient operation as an industrial process apparatus is possible.

### Solution to Problem

A hot water-flowing type saccharification apparatus according to the present invention hydrolyzes a raw material organic substance stored in a reaction pipe by passing pressurized hot water therethrough. This hot water-flowing type saccharification apparatus includes a raw material hopper which stores the raw material organic substance, a raw material-feeding pipe which receives the raw material organic substance dropped from the raw material hopper and communicates with the pipe-shaped reaction pipe, a raw material transfer unit which transfers the raw material organic substance from one end of the raw material-feeding pipe to the reaction pipe, a shutoff valve provided between the raw material-feeding pipe and the reaction pipe, a pressurized hot water supply unit which supplies the pressurized hot water to one end of the reaction pipe, and a liquid recovery unit which recovers the pressurized hot water together with a decomposition liquid from the other end of the reaction pipe.

Additionally, in the hot water-flowing type saccharification apparatus, a residue discharge unit provided in the reaction pipe on an opposite side to the raw material-feeding pipe so as to discharge a residue outside may be further included, and the raw material-feeding pipe and the raw material transfer unit may be configured to pump the raw material organic substance into the reaction pipe.

Additionally, in the hot water-flowing type saccharification apparatus, the liquid recovery unit may include a pressure maintenance valve to maintain a constant pressure within the reaction pipe.

Additionally, in the hot water-flowing type saccharification apparatus, the shutoff valve may be a ball valve in which a passage formed in a valve body has the same inner diameter as an inner diameter of the reaction pipe.

### Advantageous Effects of Invention

According to the present invention, the raw material organic substance is automatically received in the reaction pipe by collaboration of the shutoff valve, the raw material-feeding pipe, the raw material hopper and the raw material transfer unit. Therefore, a hot water-flowing type saccharification apparatus can be provided with which an efficient operation as an industrial process apparatus is possible.

### BRIEF DESCRIPTION OF DRAWINGS

FIG. 1 is a front view showing an apparatus configuration of a hot water-flowing type saccharification apparatus according to an embodiment of the present invention.

FIG. 2A is a first explanatory view showing an operation of the hot water-flowing type saccharification apparatus according to the embodiment of the present invention.

FIG. 2B is a first explanatory view showing an operation of the hot water-flowing type saccharification apparatus according to the embodiment of the present invention.

FIG. 2C is a first explanatory view showing an operation of the hot water-flowing type saccharification apparatus according to the embodiment of the present invention.

FIG. 2D is a first explanatory view showing an operation of the hot water-flowing type saccharification apparatus according to the embodiment of the present invention.

FIG. 2E is a first explanatory view showing an operation of the hot water-flowing type saccharification apparatus according to the embodiment of the present invention.

FIG. 3A is a second explanatory view showing an operation of the hot water-flowing type saccharification apparatus according to the embodiment of the present invention.

FIG. 3B is a second explanatory view showing an operation of the hot water-flowing type saccharification apparatus according to the embodiment of the present invention.

FIG. 3C is a second explanatory view showing an operation of the hot water-flowing type saccharification apparatus according to the embodiment of the present invention.

### DESCRIPTION OF EMBODIMENTS

Hereinafter, an embodiment of the present invention is described with reference to the drawings.

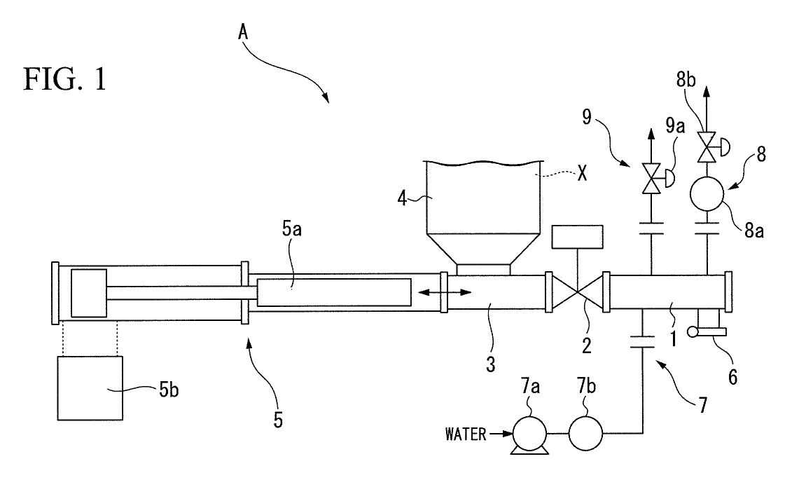

A hot water-flowing type saccharification apparatus A according to the embodiment is configured to include a reaction pipe 1, a shutoff valve 2, a raw material-feeding pipe 3, a raw material hopper 4, a raw material transfer unit 5, a residue discharge unit 6, a pressurized hot water supply unit 7, a liquid recovery unit 8, and a gas emission unit 9, as shown in FIG. 1. Additionally, in this figure, the relative size of each unit is changed in relation to its actual size for convenience.

The hot water-flowing type saccharification apparatus A is an apparatus which hydrolyzes a raw material organic substance X not continuously but in batches (intermittently) by passing pressurized hot water at a predetermined temperature (for example, 150 to 300° C.) and at a predetermined pressure or greater (for example, a predetermined pressure greater than or equal to the saturated vapor pressure) for a predetermined period of time through the raw material organic substance X stored in the reaction pipe 1. In a plant in which, for example, biomass (biological resources except for fossil resources) is turned into polysaccharides with a relatively low degree of polymerization and bioethanol is produced from monosaccharides obtained from further decomposition of the polysaccharides, the hot water-flowing type saccharification apparatus A as such functions as a front-end saccharification apparatus in which biomass is turned into polysaccharides with a relatively low degree of polymerization. Additionally, as a back-end saccharification apparatus in which monosaccaharides are obtained from polysaccharides in such a bioethanol production plant, for example, a solid acid catalyst saccharification apparatus, in which polysaccharides are acted on by a solid acid catalyst resulting in monosaccaharides, may be considered.

In Japanese Patent Application No. 2009-219362 (filed Sep. 24, 2009, Title of Invention: System and method for treating biomass), the inventors propose an apparatus and method for treating biomass to produce bioethanol (C₂H₆O). In which, a xylo-oligosaccharide and a cello-oligosaccharide are individually obtained from a polysaccharide (carbohydrate) included in biomass (woody biomass) by adjusting the temperature of hot water in a pressurized hydrothermal reaction apparatus (front-end saccharification apparatus). Then, the xylo-oligosaccharide is turned into xylose (C₅H₁₀O₅: pentose) from monosaccharification by treating the xylo-oligosaccharide in a first catalyst reaction apparatus (back-end saccharification apparatus), and the cello-oligosaccharide is turned into glucose (C₆H₁₂O₆: hexose) from monosaccharification by treating the cello-oligosaccharide in a second catalyst reaction apparatus (back-end saccharification apparatus). Further, the xylose is fermentation-treated in a first fermentation apparatus, and the glucose is fermentation-treated in a second fermentation apparatus.

As is well known, woody biomass is mainly composed of cellulose (a polysaccharide), hemicellulose (a polysaccharide), and lignin. By making pressurized hot water act on the woody biomass of this composition, the cellulose or the hemicellulose can be decomposed to polysaccharides with a lower degree of polymerization (a xylo-oligosaccharide, a cello-oligosaccharide, and various oligosaccharides with a slightly higher degree of polymerization than these). The hot water-flowing type saccharification apparatus A of the present invention has equivalent basic functions to the above-described pressurized hydrothermal reaction apparatus (front-end saccharification apparatus), receives granular biomass from the outside as a raw material, and then decomposes this raw material into, for example, a xylo-oligosaccharide or a cello-oligosaccharide.

In the hot water-flowing type saccharification apparatus A of the present invention, the reaction pipe 1 is a straight-pipe-shaped vessel which has a circular cross-section, as shown in the figure. The shutoff valve 2 is connected to one end (left end) of the reaction pipe 1, and the other end (right end) thereof is blocked. As described later, the raw material organic substance X is received within this reaction pipe 1, the pressurized hot water flows from the one end (left side) to the other end (right side), and thereby the cellulose or the hemicellulose included in the raw material organic substance X is decomposed into polysaccharides with a lower degree of polymerization (a xylo-oligosaccharide, a cello-oligosaccharide, and various oligosaccharides with a slightly higher degree of polymerization than these).

The shutoff valve 2 is a ball valve in which a passage formed in a valve body thereof has the same inner diameter as the inner diameter of, and is coaxial with, the reaction pipe 1. The raw material-feeding pipe 3 is connected to the shutoff valve 2 at the opposite side to the reaction pipe 1. The raw material-feeding pipe 3 is a straight pipe having the same inner diameter as that of the reaction pipe 1 and that of the passage of the shutoff valve 2, and also being coaxial with the reaction pipe 1. That is, the reaction pipe 1, the shutoff valve 2, and the raw material-feeding pipe 3 are provided in a straight line so that the axis thereof is arranged horizontal, as shown in the figure.

The raw material hopper 4 is provided to communicate with the raw material-feeding pipe 3 at the side of the raw material-feeding pipe 3 and stores the raw material organic substance X. That is, the lower opening of the raw material hopper 4 communicates with the opening formed at the side of the raw material-feeding pipe 3, and the raw material-feeding pipe 3 receives the raw material organic substance X dropped from the raw material hopper 4. The raw material transfer unit 5 is connected to one end (left end) of the raw material-feeding pipe 3 and transfers the raw material organic substance X received within the raw material-feeding pipe 3 to the reaction pipe 1 by extruding the raw material organic substance X from the one end (left end) of the raw material-feeding pipe 3 toward the reaction pipe 1. This raw material transfer unit 5 is configured to include a pusher pump 5a which forces out the raw material organic substance X and a hydraulic unit 5b which hydraulically drives the pusher pump 5a.

The residue discharge unit 6 is a door in an open-close state provided at the side of the opposite side to the raw material-feeding pipe 3 in the reaction pipe 1 so as to discharge a residue outside, as shown in the figures. The pressurized hot water supply unit 7 is configured to include a pressurizing pump 7a, a heater 7b and the like, and supplies the pressurized hot water to the one end (left end side) of the reaction pipe 1. The pressurizing pump 7a pressurizes water supplied from the outside to a predetermined pressure and supplies the water to the heater 7b. The heater 7b heats the pressurized water supplied from the pressurizing pump 7a to a predetermined temperature and supplies the pressurized hot water to the reaction pipe 1.

The liquid recovery unit 8 is configured to include a cooling device 8a, a pressure maintenance valve 8b and the like and recovers the pressurized hot water together with a decomposition liquid from the other end (right end side) of the reaction pipe 1. The cooling device 8a cools a process liquid discharged from the reaction pipe 1 and supplies the liquid to the pressure maintenance valve 8b. The pressure maintenance valve 8b is an adjusting valve to maintain the pressure within the reaction pipe 1 at a predetermined pressure. The gas emission unit 9 is configured to include a gas emission valve 9a and the like and emits the gas collected within the reaction pipe 1 to the outside. This gas emission valve 9a is in an on-off state.

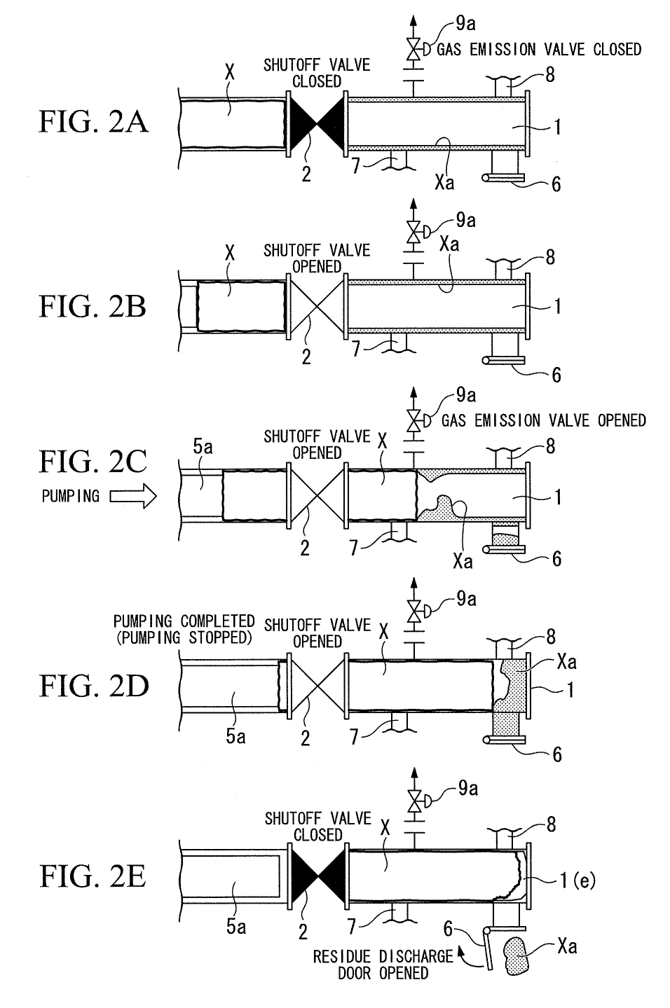

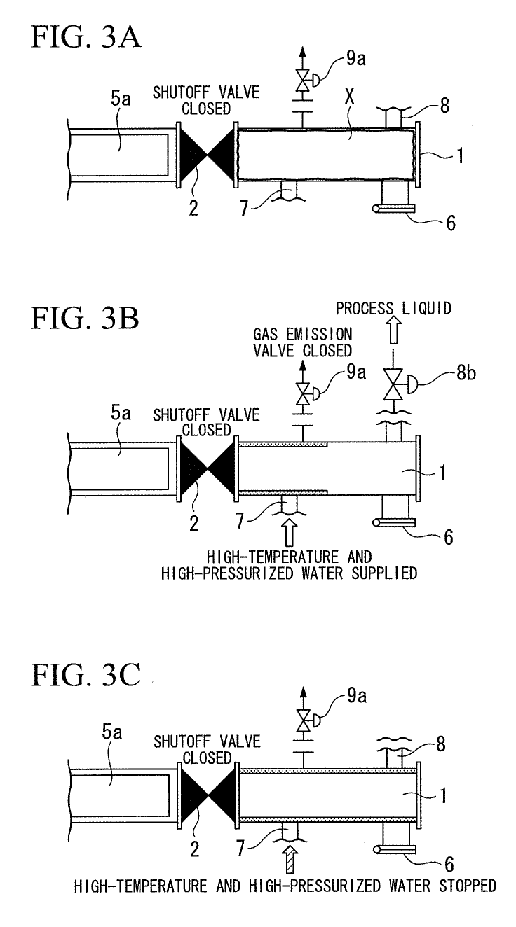

Next, an operation of the hot water-flowing type saccharification apparatus A configured as such is described in detail with reference to FIG. 2A to FIG. 3C.

FIG. 2A shows a state after treating the raw material organic substance X (for example, woody biomass) with pressurized hot water over a predetermined period of time using the reaction pipe 1. This state is a state in which the operation of the pressurized hot water supply unit 7 and the liquid recovery unit 8 is stopped and the shutoff valve 2, the gas emission valve 9a and the residue discharge unit 6 are all closed.

By pressurized hydrothermal treatment in the reaction pipe 1, among various components of the raw material organic substance X, the cellulose or the hemicellulose is decomposed into polysaccharides with a lower degree of polymerization (a xylo-oligosaccharide, a cello-oligosaccharide, and various oligosaccharides with a slightly higher degree of polymerization than these) and then recovered to the liquid recovery unit 8 with the pressurized hot water. Meanwhile, non-decomposed components such as lignin among various components of the raw material organic substance X are attached to the inner wall surface of the reaction pipe 1 as a residue Xa (solid substance) which is not decomposed by the pressurized hot water.

When the subsequent treatment of the raw material organic substance X is carried out in such a state, as shown in FIG. 2B, the shutoff valve 2 is opened. The pusher pump 5a pumps the raw material organic substance X within the raw material-feeding pipe 3 toward the reaction pipe 1 by operating the raw material transfer unit 5, and the raw material organic substance X passes through the shutoff valve 2 easily. The pusher pump 5a further extracts the raw material organic substance X toward the reaction pipe 1, and thereby the raw material organic substance X enters the reaction pipe 1 from the raw material-feeding pipe 3 through the shutoff valve 2, as shown in the FIG. 2C.

When the raw material organic substance X enters the reaction pipe 1 in this manner, since the inner diameter of the raw material-feeding pipe 3 is formed to be same as the inner diameter of the reaction pipe 1, the residue Xa attached to the inner wall surface of the reaction pipe 1 is forced out to the other end (right side) of the reaction pipe 1 by the raw material organic substance X, as shown in FIG. 2C. That is, at the same time the raw material organic substance X is stored in the reaction pipe 1, the residue Xa within the reaction pipe 1 is removed from the inner wall surface of the reaction pipe 1 and is slowly collected at the other end (right side) of the reaction pipe 1.

Furthermore, when the pumping of the raw material organic substance X by the pusher pump 5a is completed, the residue Xa is located facing to the residue discharge unit 6 provided at the other end (right side) of the reaction pipe 1, as shown in FIG. 2D. Upon completion of the storage of the raw material organic substance X in the reaction pipe 1 in this manner, the residue discharge unit 6 is made to open and the residue Xa is discharged outside of the reaction pipe 1, as shown in FIG. 2E.

Next, as shown in FIG. 3A, the shutoff valve 2, the residue discharge unit 6, and the gas emission valve 9a are all closed and the advancing preparation of the process is fully completed. T hen, as shown in FIG. 3B, the pressurized hot water supply unit 7 and the liquid recovery unit 8 start operation, the pressurized hot water (high-temperature and high-pressurized water) is supplied to the one end (left side) of the reaction pipe 1 sequentially, the process liquid is recovered from the other end (right side) of the reaction pipe 1 sequentially, and thereby the raw material organic substance X within the reaction pipe 1 is decomposed. In the decomposition process of the raw material organic substance X in this state, the degree of opening of the pressure maintenance valve 8b is adjusted so that the reaction pressure within the reaction pipe 1 is maintained at a predetermined value. Furthermore, if the flowing status of the pressurized hot water (high-temperature and high-pressurized water) with regard to the raw material organic substance X, that is, the decomposition process is continued for a predetermined period of time (processing time), the pressurized hot water supply unit 7 and the liquid recovery unit 8 stop operation and the decomposition process of the raw material organic substance X is completed, as shown in FIG. 3C.

According to the present embodiment, the raw material organic substance X is automatically received in the reaction pipe 1 by collaboration of the shutoff valve 2, the raw material-feeding pipe 3, the raw material hopper 4, and the raw material transfer unit 5. Additionally, when receiving the raw material organic substance X in the reaction pipe 1, the residue Xa attached to the inner wall surface of the reaction pipe 1 is automatically removed from the inner wall surface and discharged outside through the residue discharge unit 6. Therefore, a hot water-flowing type saccharification apparatus with which an efficient operation as an industrial process apparatus is possible can be provided.

Additionally, the present invention is not limited to the above embodiment and, for example, modified examples as follows may be considered.

(1) In the embodiment, the raw material organic substance X is pumped into the reaction pipe 1 using the pusher pump 5a; however, the configuration of the raw material transfer unit 5 is not limited to this. For example, in a case where the removal of the residue Xa may not have to be considered, the raw material transfer unit 5 may not pump the raw material organic substance X. Since pumping the raw material organic substance X requires a relatively large amount of power, the power required to transfer the raw material organic substance X can be reduced when the configuration in which the raw material organic substance X is not pumped is adopted.

(2) In the embodiment, the residue discharge unit 6 is provided at the side of the reaction pipe 1; however, the present invention is not limited to this. For example, the residue discharge unit 6 may be provided at the other end (right end) of the reaction pipe 1. Regarding the configuration of the residue discharge unit 6, it is preferable that more residue Xa be discharged outside more reliably.

(3) In the embodiment, the case in which there is one reaction pipe 1 has been described; however, the present invention is not limited to this. In order to treat more raw material organic substance X, a plurality of reaction pipes 1 may be provided and also, each component described in the embodiment may be provided in each reaction pipe 1.

### INDUSTRIAL APPLICABILITY

According to the present invention, a hot water-flowing type saccharification apparatus with which an efficient operation as an industrial process apparatus is possible can be provided.

### REFERENCE SIGNS LIST

A . . . hot water-flowing type saccharification apparatus
1 . . . reaction pipe
2 . . . shutoff valve
3 . . . raw material-feeding pipe
4 . . . raw material hopper
5 . . . raw material transfer unit
6 . . . residue discharge unit
7 . . . pressurized hot water supply unit
8 . . . liquid recovery unit
9 . . . gas emission unit

1. A hot water-flowing type saccharification apparatus which hydrolyzes a raw material organic substance stored in a reaction pipe by passing pressurized hot water therethrough, comprising:
a raw material hopper which stores the raw material organic substance;
a raw material-feeding pipe which receives the raw material organic substance dropped from the raw material hopper and communicates with the pipe-shaped reaction pipe;
a raw material transfer unit which transfers the raw material organic substance from one end of the raw material-feeding pipe to the reaction pipe;
a shutoff valve provided between the raw material-feeding pipe and the reaction pipe;
a pressurized hot water supply unit which supplies pressurized hot water to one end of the reaction pipe; and
a liquid recovery unit which recovers the pressurized hot water together with a decomposition liquid from the other end of the reaction pipe.

2. The hot water-flowing type saccharification apparatus according to claim 1, further comprising:
a residue discharge unit provided in the reaction pipe on an opposite side to the raw material-feeding pipe so as to discharge a residue outside, wherein
the raw material-feeding pipe and the raw material transfer unit are configured to pump the raw material organic substance into the reaction pipe.

3. The hot water-flowing type saccharification apparatus according to claim 1, wherein
the liquid recovery unit includes a pressure maintenance valve to maintain a constant pressure within the reaction pipe.

4. The hot water-flowing type saccharification apparatus according to claim 2, wherein
the liquid recovery unit includes a pressure maintenance valve to maintain a constant pressure within the reaction pipe.

5. The hot water-flowing type saccharification apparatus according to claim 1, wherein
the shutoff valve is a ball valve in which a passage formed in a valve body has the same inner diameter as an inner diameter of the reaction pipe.
